(19) United States
(12) Patent Application Publication
(10) Pub. No.: US 2013/0198096 A1
(43) Pub. Date: Aug. 1, 2013

(54) METHOD AND SYSTEM FOR SHIPPING VIA A SOCIAL NETWORK

(71) Applicants: Daniel Lynch, Bridgewater, CT (US); Donald M. Eager, Milford, CT (US); Eric J. Albrecht, Hamden, CT (US)

(72) Inventors: Daniel Lynch, Bridgewater, CT (US); Donald M. Eager, Milford, CT (US); Eric J. Albrecht, Hamden, CT (US)

(73) Assignee: Neopost Technologies, Bagneux (FR)

(21) Appl. No.: 13/361,176

(22) Filed: Jan. 30, 2012

(51) Int. Cl. G06Q 10/08; G06Q 99/00

(52) U.S. Cl. 705/319

(57) ABSTRACT

Systems and methods for shipping to be executed within the framework of a social networking system or social network using information managed within the social networking system through interfaces to carriers that perform the shipping are provided. Shipping registration information for a first user of a social networking system is received, wherein the shipping registration information includes a physical address and at least one authorized payment mechanism. A request by the first user to ship a physical item to a second user of the social networking system is received at the social networking system. Shipping information including a physical address is obtained from the second user. A shipping label for shipping the physical item is generated and provided to the first user for shipping the physical item to the second user.

### BACKGROUND

Social networks or social networking systems (e.g., Facebook, LinkedIn and others) are designed to form communities for the sharing of information over the internet. Social networking systems may include various other systems, such as social media, media sharing, common-interest, and other types of services and websites. A social network user can create groups of friends, coworkers, families, etc. and communicate with those groups. Social network groups often share electronic items such as personal information including contact or biographical information, digital pictures, digital music and books, electronic documents and other information and material. Generally, items shared within a social network are electronic and can be passed among users within the social network or otherwise shared via the internet. In some instances, the use of a social network allows sharing of these electronic items among users that have limited knowledge about one another. For example, two “friends” may choose to communicate and share electronic items without knowledge of each other's phone numbers or physical address.

### BRIEF SUMMARY

The invention provides advantageous methods and systems for shipping functionality within social networking communities, such that the process of sharing physical items is similar to an extension of the sharing of the electronic items that are currently shared within the community. Some embodiments may include partial or complete privacy, similar to privacy controls and other features that conventional social networks may provide.

An embodiment of the disclosed subject matter may include receiving shipping registration information for a first user of a social networking system. The shipping registration information may include a physical address and at least one authorized payment mechanism. A request by the first user to ship a physical item to a second user of the social networking system may be received, such as by the social networking system. The system may obtain shipping information for the second user, such as a physical address. A shipping label with the physical address may then be generated for shipping the physical item from the first user to the second user. The method concludes by providing the shipping label to the first user.

An embodiment of the disclosed subject matter includes a system that may store shipping registration information for a first user of a social networking system, which can include a physical address and at least one authorized payment mechanism. The system may receive a request by the first user to ship a physical item to a second user, obtain shipping information for the second user, and generate a shipping label for shipping the physical item from the first user to the second user. The shipping label may include a physical address obtained from, or provided with, the shipping information. The shipping label may then be provided to the first user.

Additional features, advantages, and embodiments of the invention may be set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the disclosed subject matter, are incorporated in and constitute a part of this specification, illustrate embodiments of the invention and together with the detailed description serve to explain the principles of the disclosure. No attempt is made to show structural details of the disclosure in more detail than may be necessary for a fundamental understanding of the disclosure and various ways in which it may be practiced.

FIG. 1 shows an example process for generating a shipping label according to an embodiment of the disclosed subject matter.

FIG. 2 shows an example system according to an embodiment of the disclosed subject matter.

FIG. 3 shows an example of a secret shipping label according to an embodiment of the disclosed subject matter.

FIG. 4 shows an example of a replacement shipping label according to an embodiment of the disclosed subject matter.

FIG. 5 shows a computer system according to an embodiment of the disclosed subject matter.

### DETAILED DESCRIPTION

A social networking system serves as a gateway through which communication between users is routed. A user may connect to a social networking system and provide registration information such as, for example, the user's name (or pseudonym), and an electronic mail address at which the user may be reached, and/or to which communication from other registered users may be directed. In this way, registered users of the social networking system may search for, and/or seek other registered users, in a manner that will be appreciated by one of skill in the art. Once each user registers with the social networking system and acknowledges the other user as a “friend”, “connection”, or the like, they typically may begin to communicate and share electronic items with each other.

On the other hand, in order to share or otherwise transport physical items, for example mailpiece, parcel, package, letter, and the like, a social networking user would, in essence, need to leave that network, establish a “relationship” with the intended receiver of these physical items outside the social network, which may require the user, such as a shipper and/or receiver, to provide more personal information than desired. A user would also need to identify a method of transport (i.e., select and retain a shipping service) and execute any processes required to perform that shipment. All of the steps associated with moving a physical item from one place to another; choosing a carrier, identifying pricing, creating a shipping label, checking the shipment status (tracking) and verifying delivery are performed outside the social network community.

Many occasional shippers also may not be familiar with use of the dedicated carriers' shipping applications, and/or may want to avoid at least some of the hassles associated with traveling to a retail shipping services location.

Additionally, there is a heightened interest on the part of the carriers and various regulatory agencies to have insight into the identity of shippers, in order to have traceability relating to the shipment of contraband goods, such as weapons, drugs, and other harmful substances and items.

Embodiments of the disclosed subject matter may allow this process to be executed within the framework of a social networking system, using information managed within the system. Embodiments also may provide interfaces to the carriers that perform the physical shipping. Embodiments may allow transfer of, for example, a physical picture album, to be accomplished as readily as an electronic transfer of an electronic version of the same album.

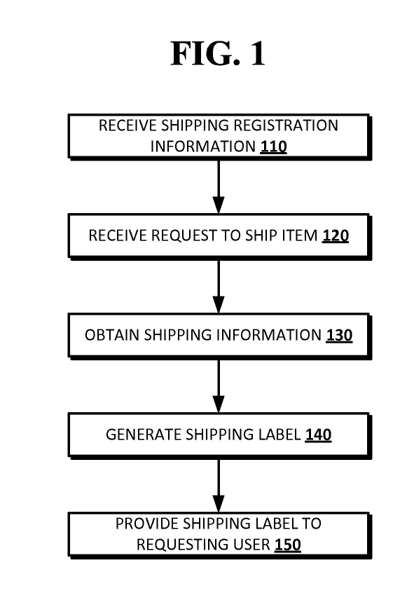

FIG. 1 shows an example process for generating a shipping label within a social networking system according to an embodiment of the disclosed subject matter. The general steps illustrated in FIG. 1 may include various sub-steps and/or additional features, which are described in further detail herein. At 110, the system may obtain shipping registration information from one or more users of the social networking system. For example, the system may obtain a mailing address from a user during registration of the user with the system, or during a dedicating shipping registration operation. At 120, a request may be received from a first user to ship a physical item to a second user. At 130, the system may obtain shipping information for the first and/or second users. For example, the system may access previously-provided shipping information received from the first and/or second users. The system also may request such information from the requesting user and/or the intended recipient second user. At 140, the social networking system, a carrier system, or a combination thereof may generate a shipping label based upon the obtained shipping information. As described in further detail herein, the shipping label may include one or both of the first and second users' mailing address. The addresses may be included in human-readable or machine-readable form. As used herein, the term “machine-readable” shall refer to a representation that may be read by a machine, but cannot be recognized or understood by a human, such as a bar-code or wartermark, for example. At 150, the shipping label may be provided to the requesting user, for use in shipping the physical item to the second user. As described herein, the various steps shown in FIG. 1 may include various other features, and may be performed in an order other than the specific order illustrated. In some cases, additional steps may be performed and steps shown for illustration in FIG. 1 may be omitted without departing from the scope of the disclosed subject matter.

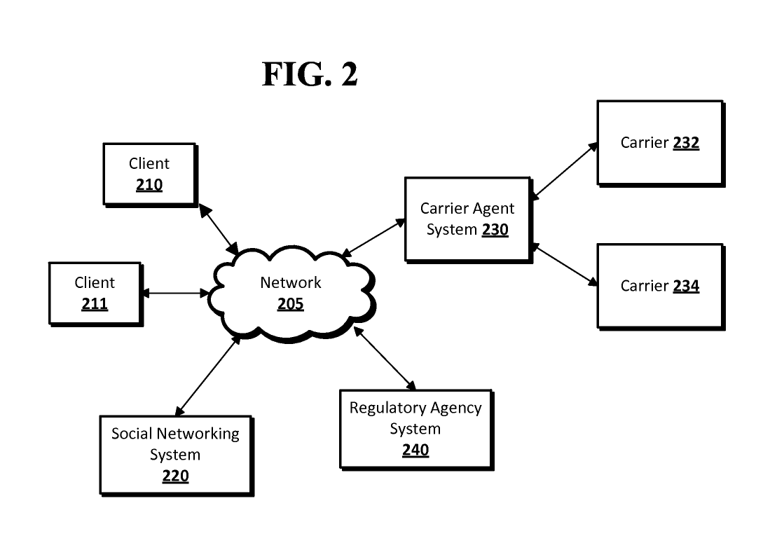

FIG. 2 shows an example system and network arrangement according to an embodiment of the disclosed subject matter. One or more clients 210, 211, such as local computers, smart phones, tablet computing devices, and the like may connect to other devices via one or more networks 205. The network may be a local network, wide-area network, the Internet, or any other suitable communication network or networks, and may be implemented on any suitable platform including wired and/or wireless networks. The clients may communicate with a social networking system 220, a carrier agent system 230, and/or one or more carrier systems 232, 234. The social networking system 220, carrier agent system 230, and/or the carrier systems 232, 234 may be directly accessible by the clients 210, 211, or one or more other devices may provide intermediary access such as where the carrier agent system 230 provides access to multiple carrier systems 232, 234. As described herein, the carrier agent system 230 may provide aggregated information and/or a single point of contact for multiple carriers 232, 234, such as to provide comparative rate information, manage users' shipping information and route such information to the carriers, and the like.

In an embodiment of the invention, the social networking system may inquire during the registration process whether the user would like to utilize a feature, such as “physical item sharing” or the like, to allow for transfer of physical items between the user and other users of the social networking system. That is, the system may determine whether the user wishes to allow shipping of physical items to the user by other users, or may wish to ship physical items to other users of the social networking system. If the user answers in the affirmative, the social networking system may connect the user with the carrier agent system 230. The carrier agent system 230 may provide an additional registration process, for example to allow users who supply the required information to share physical items via the carrier's shipping services in a manner analogous to the current sharing of electronic items. Registration with the carrier agent system 230 may require shipping registration information such as information about the user's physical address. The carrier agent system 230 may further perform a physical address verification, to insure that the user does, in fact, live at the claimed physical address. For example, the carrier system 230 may create and send a postcard with a printed code to the claimed physical address, and require the user to subsequently enter the code upon the postcard to verify that the user received the postcard at the specified address.

The carrier agent system 230 also may request payment information, such as a credit card account number, banking account number, or the like, which may be used to provide payment for the costs associated with sharing physical items, such as shipping of mailpieces or physical items via the carrier.

In an embodiment, the social networking system 220 acts as a proxy for the carrier agent system 230, and requests the information required by the carrier agent system 230 directly of the user. Thus, the social networking system 220 may act as a “broker” with regard to the sharing of physical items. In this case, the user may not be aware of the presence of the carrier agent system 230.

The carrier agent system 230 may be programmed to request information from the user that is sufficient to satisfy the informational requirements of at least one carrier service. Different carrier services may be associated with different carriers 232, 234, such as UPS, USPS, Federal Express, and the like. In instances where different carriers 232, 234 have different informational requirements, the carrier agent system 230 may request information to fill the requirements of all the different carrier services 232, 234; in the event that the user fails to answer all informational requirements, only such carrier services for which the informational requirements are satisfied will be considered for sharing of the physical items.

According to an embodiment, a first user and a second user may be registered users with the social networking system 220, and may have authorized, created, accepted, and/or initiated a social relationship within the social networking system with the other, establishing a channel of communication with the other. In particular, once the social relationship is created, the first and second users are connected by the social relationship allowing one or both of the first and second users to use additional features of the social networking system. For example, the first and/or second users may be able to share data, control access permissions for the other user relative to non-connected registered users, view profile information for the other, and the like, as would be understood by one of skill in the art. The first user and second user may be referred to as “friends”, “connections”, or the like, depending upon the terminology used by the specific social networking system 220.

The first user and second user, as part of their registration process with the social networking system 220, may indicate that they would like to be able to share physical items with other users. As such, they will perform a physical item sharing information registration with the social networking system 220 and/or a carrier agent system 230, either directly, or indirectly via the social networking system 220, as previously described. Such shipping information registration may include providing shipping information such as the user's physical address and one or more authorized payment mechanisms as previously described. A validation of the physical address may occur as previously described, such as via a post card mailed to the physical address with a code that the user provides to the carrier agent system 230. The shipping information registration process may include asking the user whether they desire to display or keep secret their shipment address to other users. Registration with some carrier services also may entitle the user to a discount.

In an embodiment, a first user may wish to ship a physical item to a second user of a social networking system. The social networking system 220 may provide an interface to allow for such a shipment, such as in part of a conventional messaging interface that can be used to send electronic messages or items between users. For example, the first user may write a message via a typical messaging dialog box. The dialog may provide, for example, a conventional attachment paperclip icon, as conventionally used to allow the first user to share an electronic item. The dialog also may include an interface, such as an icon of a package, which will allow the first user to share a physical item.

If the first user selects the “share physical item” icon or other interface, the social networking system 220 may determine if either or both of the first and second users in the conversation have been registered for physical item sharing, and may obtain shipping information for one or both users. For example, the social networking system 220 may query a carrier 232, 234 or a carrier agent system 230 to determine if shipping information is available for either or both users. If the first user is not registered, the social networking system 220 may require shipping registration information before the shipment may proceed. If the second user is not registered, the social networking system may require that the first user provide the second user's delivery address to which the physical item is to be shipped. The social networking system also may attempt to obtain the second user's shipping information from another source, such as a carrier 232, 234 or a carrier agent system 230. If the second user is registered, the social networking system 220 may display shipment options available for the first user to ship the physical item to the second user. In a configuration where multiple carriers 232, 234 are available, the system 220 may display the various carrier services and corresponding costs for the first user to select. After the first user selects a desired carrier service, the social networking system 220 may provide the appropriate information to the carrier 232, 234, directly or by way of a carrier agent system 230 which forwards it to the carrier service 232, 234.

The social networking system 220 and/or a carrier service 232, 234 may provide an image file of a carrier-compliant shipment label with the necessary formatting to the first user. The carrier-compliant shipment label includes the necessary carrier-specific information for the carrier to accept and process the shipment of the physical item, as will be understood by one of skill in the art. The first user can then print the shipment label and attach it to the physical item for shipping to the second user.

The carrier service 232, 234 may query a carrier, carrier agent system 230, or social networking system 220, as appropriate, to determine if the second user has indicated that their address should be shared or kept secret. If the second user has indicated the address may be shared, the shipment label may include a human-readable indication of the shipping information, such as the second user's physical address. If the second user has indicated the address should be kept secret, the shipment label may, instead of a human-readable address, include a machine-readable indication of the second user's address. The machine-readable indication may be, for example, a barcode, QR code, or other machine-readable indication. The machine-readable indication may be an encoded form of the address. The machine-readable indication also may be an identifier or an encoded form of a unique identifier, such as may be assigned to the second user in a look-up table maintained in or by the carrier service 232, 234. In this way, upon receipt of the physical item, the carrier service may decode the machine-readable indication to determine the second user's mailing address. In any case, the shipment label may additionally include a unique shipment identifier that specifically identifies the particular physical item, such that track and trace functionality may be provided.

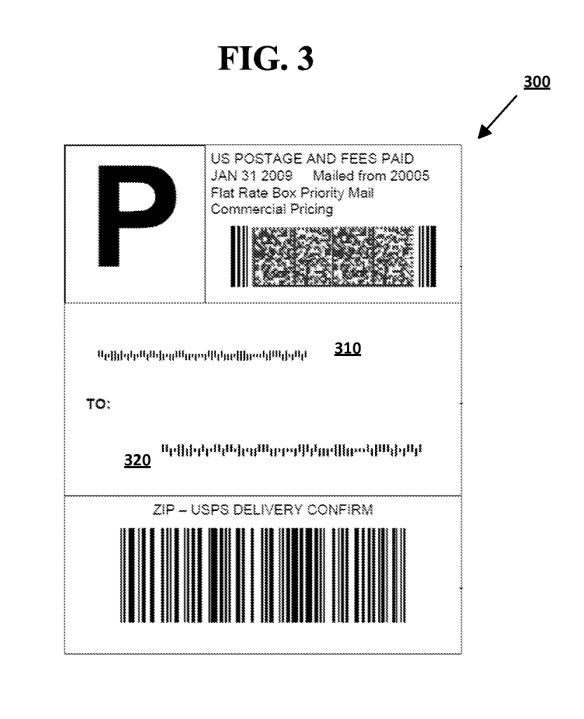

FIG. 3 shows an example of a shipping label 300 that includes machine-readable indications of shipping information. The example shipping label 300 includes a machine-readable return address 310 and a machine-readable shipping address 320. More generally, one or both of the return address and the shipping address may be encoded so as to be machine-readable as described.

Once the package is in the carrier's possession, the carrier may continue to process the package via scanning of the machine-readable indications 310, 320, or may generate a human-readable shipment label that includes the second user's address for ease of delivery. The human-readable shipment label may include the first user's address, such as a return address. Alternatively, if during the shipment registration process, the first user indicated a preference to keep their address secret, the human-readable shipment label may indicate the first user's name or pseudonym, or a machine-only readable indication of the first user's address.

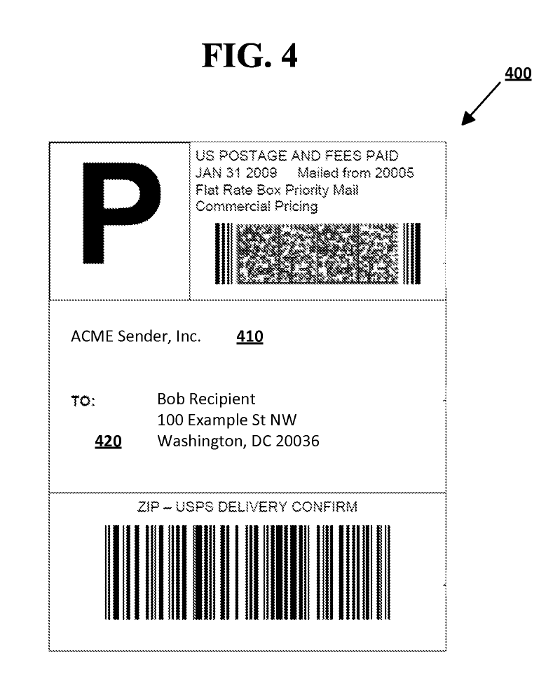

FIG. 4 shows an example replacement shipping label 400 that may be generated by the carrier service and includes a human-readable sender name 410 and a human-readable shipping address 420. More generally, some or all of both or either the return address and the shipping address may be shown in human-readable form. In some cases, part of one or both of the addresses may be shown in human-readable form, and the remainder in machine-readable form. For example, the return address may include a human-readable name 410, and a machine-readable mailing address. Such configurations may be useful, for example, where a sender wishes to reveal his or her identity, but not provide his complete mailing address.

In an embodiment, a regulatory agency system 240 may connect with either the carrier agent system 230 or the social networking system 220 to monitor physical item sharing activity as may be needed. In some instances, various governmental or other official agencies may wish to know prospectively, or be able to confidently determine retroactively, the identity of a shipper (first user) and/or recipient (second user), particularly if a physical item is found to include contraband materials. As such, the carrier and/or the social networking service may connect to the regulatory agency system 240 to ensure that shippers and recipients are authorized to share materials, and are not, for example, on any pre-determined “No Share” lists that may be defined on a basis of the identities and/or physical address associated with the users. The identities, locations, and/or physical addresses associated with the users may be maintained by the social networking system 220 and/or carrier agent system 230 via their respective registration processes.

In an embodiment, in response to creation of the shipping label 300, 400, the social networking system may send a private message to the second user indicating that a physical item is being shipped to them. The private message may indicate, for example the default delivery address provided by the second user during the shipping information registration process, the delivery address entered by the first user, or the like. In particular, the private message may allow or provide an option for the second user to indicate a different desired delivery address. If the second user provides a different delivery address, it may be forwarded from the social networking system 220 to the carrier 232, 234 or the carrier agent system 230, so that the carrier service may update the delivery address associated with the unique shipment identifier. The updated address may then replace the default delivery address. If the carrier service replaces the shipping label printed by the first user as described above with reference to FIG. 4, the updated address may be human-readable.

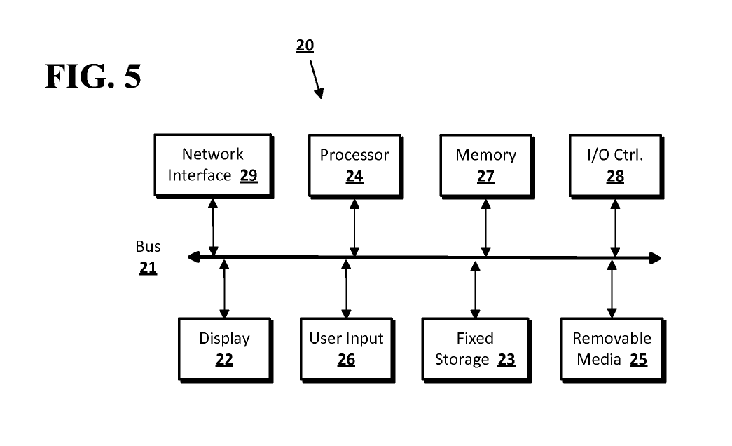

Embodiments of the invention may be implemented in and used with a variety of component and network architectures. FIG. 5 is an example computer 20 suitable for implementing embodiments of the invention. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 4 need not be present to practice the present disclosure. The components can be interconnected in different ways from that shown. The operation of a computer such as that shown in FIG. 4 is readily known in the art and is not discussed in detail in this application. Code to implement the present disclosure can be stored in computer-readable storage media such as one or more of the memory 27, fixed storage 23, removable media 25, or on a remote storage location.

More generally, various embodiments may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing embodiments of the invention. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing embodiments of the invention. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to various embodiments in hardware and/or firmware. The processor may be coupled to memory, such as RAM, ROM, flash memory, a hard disk or any other device capable of storing electronic information. The memory may store instructions adapted to be executed by the processor to perform the techniques disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

1. A computer-implemented method comprising:
receiving shipping registration information for a first user of a social networking system, the shipping registration information comprising a physical address of the first user and at least one authorized payment mechanism;
receiving at the social networking system a request by the first user to ship a physical item to a second user of the social networking system;
obtaining shipping information for the second user, the shipping information comprising a physical address of the second user;
generating a shipping label for shipping the physical item from the first user to the second user, the shipping label comprising the physical address of the second user, and
providing the shipping label to the first user.

2. The method of claim 1, wherein the first and second users are connected by a social relationship within the social networking system.

3. The method of claim 1, wherein the step of receiving shipping registration information for the first user is performed after the step of receiving the request by the first user to ship the physical item to the second user.

4. The method of claim 1, wherein:
the step of obtaining shipping information for the second user comprises obtaining shipping registration information from the second user by the social networking system, the shipping registration information comprising a physical address of the second user.

5. The method of claim 4, wherein the shipping registration information is obtained from the second user prior to receiving the request by the first user to ship the physical item to the second user; and
the shipping information for the second user is retrieved from the social networking system.

6. The method of claim 4, wherein:
the shipping information from the second user is indicated as secret by the second user; and
the shipping label comprises a machine-readable indication of the shipping information for the second user.

7. The method of claim 1, wherein the step of obtaining the shipping information for the second user from the first user.

8. The method of claim 1, wherein:
the shipping registration information for the first user is indicated as secret by the first user; and
the shipping label comprises a machine readable indication of shipping information for the first user.

9. The method of claim 1, wherein the shipping label comprises a human-readable indication of the shipping information for the second user.

10. The method of claim 1, further comprising receiving shipping registration information from a carrier agent system.

11. The method of claim 1, further comprising receiving shipping registration information from the social networking system.

12. The method of claim 1, wherein the social networking system sends a private message to the second user indicating that the physical item has been shipped.

13. The method of claim 12, further comprising receiving a request by the second user to change the shipping information for the physical item which has been shipped.

14. The method of claim 1, further comprising providing the shipping registration information for at least one of the first user and the second user to a governmental agency.

15. The method of claim 1, further comprising querying at least one carrier service to obtain shipping pricing information based on the shipping information for the second user.

16. The method of claim 15, further comprising a step of displaying the shipping pricing information to the first user.

17. A computer system comprising:
a computer-readable medium storing shipping registration information for a first user of a social networking system, wherein the shipping registration information comprises a physical address and at least one authorized payment mechanism;
a processor configured to:
receive a request by the first user to ship a physical item to a second user;
obtain shipping information for the second user, the shipping information comprising a physical address;
generate a shipping label for shipping the physical item from the first user to the second user, the shipping label comprising the physical address, and
provide the shipping label to the first user.

18. The system of claim 17, wherein the shipping registration information for the first user is received after the request by the first user to ship the physical item to the second user of the system is received.

19. The system of claim 17, wherein:
shipping registration information for the second user is obtained from the second user by the social networking system and comprises the shipping information for the second user.

20. The system of claim 19, wherein:
the shipping registration information is obtained from the second user prior to the request by the first user to ship the physical item to the second user is received; and
the shipping information for the second user is retrieved from the social networking system.

21. The system of claim 17, wherein the shipping information for the second user is obtained from the first user.

22. The system of claim 17, wherein:
the shipping information for at least one of the first user and the second user is indicated as secret; and
the shipping label comprises a machine-readable indication of the shipping information indicated as secret.
